(19) United States
(12) Patent Application Publication
(10) Pub. No.: US 2015/0148007 A1
(43) Pub. Date: May 28, 2015

(54) PHONE LOCK SYSTEM

(71) Applicant: Asurion, LLC, Nashville, TN (US)

(72) Inventors: Joshua M. Mitchell, San Antonio, TX (US); Richard Reybok, Half Moon Bay, CA (US); Michael Ballou, Irvine, CA (US)

(73) Assignee: Asurion, LLC, Nashville, TN (US)

(21) Appl. No.: 14/089,345

(22) Filed: Nov. 25, 2013

(51) Int. Cl. H04W 12/12

(52) U.S. Cl. CPC H04W 12/12
USPC 455/411

(57) ABSTRACT

Technologies related to mobile communication devices are disclosed. A mobile communication device is identified, including identifying a unique identifier associated with the mobile communication device. An application is stored in firmware of the mobile communication device. The application is executed at boot-up and periodically when the mobile communication device is operating. Executing the application includes checking with a service to ensure that the mobile communication device is confirmed to be operational, including providing the unique identifier to the service. A confirmation is received that the mobile communication device is confirmed to be operational, and when so, waiting until a next check time for further processing. Upon receiving an indication that the device is confirmed to no longer be operational, a script is executed that locks the device, including creating a password, locking the mobile communication device with the password, and disabling a USB port that is included in the device.

### FIELD

This patent document generally relates to mobile communication devices.

### BACKGROUND

Cellular telephones and other mobile communication devices are attractive targets for thieves because of their value and relatively small size. When a cellular telephone is stolen, for example, a thief may be able to easily sell or re-program the device to make it re-usable by someone other than the owner. For example, a device may be reprogrammed by a factory reset such as initiated through an external connection (e.g., using a port). As an example, a universal serial bus (USB) port on the device may be able to be used, e.g., to interface with another computer in order to override or defeat any security system on the device.

### SUMMARY

This document describes, among other things, technologies relating to mobile communication devices. In one aspect, a computer implemented method is provided that includes identifying a mobile communication device, including identifying a unique identifier associated with the mobile communication device. The method further includes storing code (e.g., an application) in firmware of the mobile communication device and executing the application at both boot-up and periodically when the mobile communication device is operating. Executing the application includes checking with a service to ensure that the mobile communication device is confirmed to be operational (e.g., not lost or stolen), including providing the unique identifier to the service. Executing the application further includes receiving a confirmation that the mobile communication device is confirmed to be operational, and when so, waiting until a next check time for further processing. Executing the application further includes, upon receiving an indication that the mobile communication device is confirmed to no longer be operational, executing instructions (e.g., a script) that locks the mobile communication device. Executing the instructions includes creating a password, locking the mobile communication device with the password, and disabling an external interface port (e.g., a USB port) that is included in the mobile communication device.

These and other implementations may include one or more of the following features. The mobile communication device can be a cellular telephone or a tablet computer, and the service can be a server based service that is accessed using either a cellular, wifi or other communication network. The unique identifier can be associated with the mobile communication device and not a service activated by the device. The unique identifier can be an IMSI SIM ID, an IMEI Device ID, a wifi MAC address, an Android ID, or a unique application ID. Storing the application can include pre-loading the application in the firmware in a system partition. The method can further include receiving, at the service, an indication from an owner of the mobile communication device that the device has been compromised, and providing, by the service, the indication. Creating the password can include generating a random alphanumeric string and using the random alphanumeric string as the password. The mobile communication device can be an Android device, and locking and creating a password can include using an Android API to facilitate the locking and password creation. The method can further include determining, by the application, that a factory reset of the mobile communication device has occurred or that the firmware has been re-written, determining a previous locked state of the mobile communication device, and locking the mobile communication device after the factory reset or the firmware re-write based on the previous locked condition. The method can further include determining, by the application, that the mobile communication device has been used unpredictably, and locking the mobile communication device. The method can further include providing a status update to the service that the mobile communication device has been locked based on the detected unpredictability, receiving an unlock command from the service when the mobile communication device is confirmed to be operational, and unlocking the mobile communication device. The method can further include detecting that a SIM card in the mobile communication device has been removed, and locking the mobile communication device. The method can further include providing a status update to the service that the mobile communication device has been locked based on the removal of the SIM card, receiving an unlock command from the service when the mobile communication device is confirmed to be operational, and unlocking the mobile communication device.

In another aspect, a computer program product embodied in a non-transitive computer-readable medium includes instructions, that when executed, cause one or more processors to perform operations including identifying a mobile communication device, including identifying a unique identifier associated with the mobile communication device, storing an application in firmware of the mobile communication device, and executing the application at boot-up and periodically when the mobile communication device is operating. Executing the application includes checking with a service to ensure that the mobile communication device is confirmed to be operational, including providing the unique identifier to the service, receiving a confirmation that the mobile communication device is confirmed to be operational, and when so, waiting until a next check time for further processing, and upon receiving an indication that the mobile communication device is confirmed to no longer be operational, executing a script that locks the mobile communication device. Executing the script includes creating a password, locking the mobile communication device with the password, and disabling a USB port that is included in the mobile communication device.

In another aspect, a system is configured to lock a mobile communication device. The system includes a mobile communication device including a memory, the memory including firmware that configures and operates the mobile communication device. The system includes a server component that includes a service for communicating with the mobile communication device, wherein the service is operable to communicate with the mobile communication device periodically to validate the current operational status of the mobile communication device. The mobile communication device includes an application that is stored in the firmware that is configured to periodically communicate with the service and, upon receipt of a lock command, to lock the mobile communication device including creating a new password for use in locking the device, locking the device using the new password, and disabling an external communication port of the mobile communication device.

Particular configurations of the technology described in this document can be implemented so as to realize none, one or more of the following potential advantages. A service can remotely activate a persistent device lock on a mobile communication device, including at the firmware level to prevent unlocking. The locking service can lead to a reduction in thefts of mobile communication devices as the diminished (i.e., minimal) value of the locked devices will in turn minimize the attractiveness of the device for that purpose. The owner of a stolen mobile communication device can report the theft to a service and have the device locked remotely, which can prevent personal information stored on the device from being compromised. The locking operation can as well include other operations, such as the destruction of private data on the device under certain circumstances.

Details of one or more implementations of the subject matter described in this document are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 shows a diagram of an example sequence for locking a mobile communication device.

FIG. 2 shows a diagram of an example device storage for a mobile communication device.

FIG. 3 is a diagram of an example environment for locking a mobile communication device.

FIG. 4 shows a flowchart of an example of a process for disabling a mobile communication device.

FIG. 5 shows a flowchart of an example of a process for locking a mobile communication device.

FIG. 6 shows a diagram of an example configuration of the mobile communication device connected to an external computer.

FIG. 7 shows a simplified architecture of an example mobile communication device.

Like reference symbols in the various drawings indicate like elements.

### DETAILED DESCRIPTION

This disclosure identifies methods, systems, apparatus and techniques for locking a mobile communication device at the firmware level. For example, the locking can be initiated by a server-based service that has been notified that the mobile communication device has been stolen and that a lock should be activated. The service can send a lock command, for example, to a lock application on the mobile communication device, which can lock the device at the firmware level using, for example, a randomly-generated password. The lock application can also perform other functions, such as disabling access to the device through an external service, such as using a universal serial bus (USB) port on the mobile communication device.

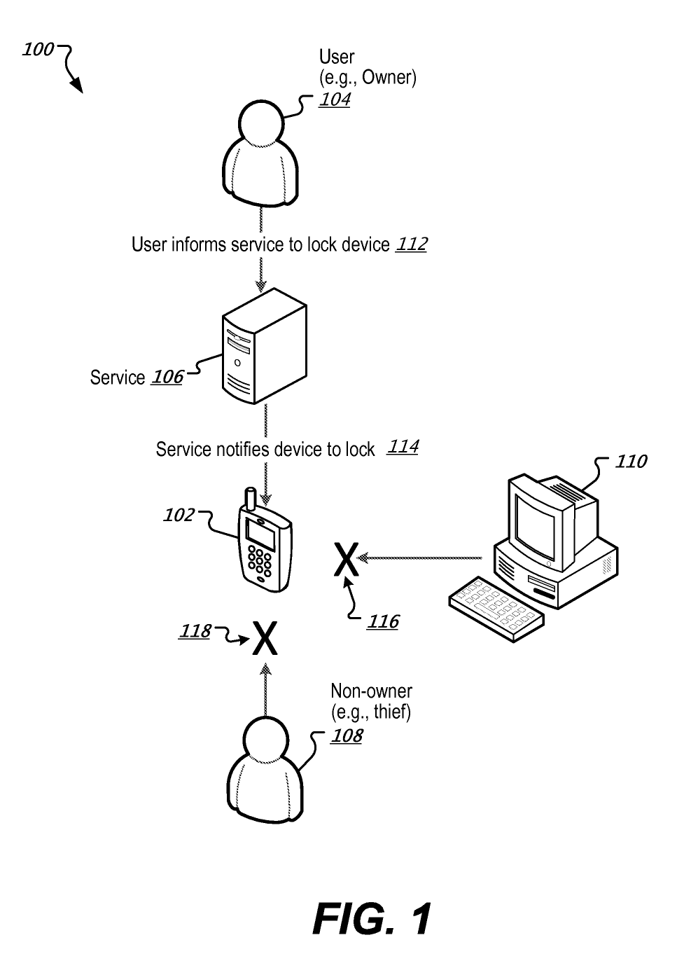

FIG. 1 shows a diagram of an example system 100 for locking a mobile communication device 102. For example, the mobile communication device 102 can be a cellular telephone (e.g., a smartphone), a tablet computer, or some other mobile device that is owned by a user 104. If the mobile communication device 102 is stolen or lost, for example, the user 104 can contact (112) a service 106 to lock (114) the mobile communication device 102. The service 106 can include, for example, one or more servers for communicating with (and locking, as needed) mobile communication devices 102. While the mobile communication device 102 is in a locked state, for example, external computers 110 can be prevented (116) from communicating with the mobile communication device 102, e.g., by disabling a USB port on the device thus preventing connection between the external computer 110 and the mobile communication device 102. When the mobile communication device 102 is in a locked state, non-owner users 108 are prevented (118) from using the mobile communication device 102. Non-owner users 108 can include, e.g., a person who stole the mobile communication device 102 from the user 104 and/or persons to whom the non-owner user(s) 108 have sold the stolen mobile communication device 102.

In some implementations, the service 106 can initiate locking the mobile communication device 102 by communicating with a locking application that is resident within firmware on the mobile communication device 102. For example, the lock application can run continuously or periodically in the background and waiting for a lock command from the service 106. The command can be pushed by the service, or the locking application can pull the information, such as by providing a request for validation of the operational state. In response to the request, the service can provide instructions or commands, one example of which is the lock command. This command can be delivered by any mechanism including, but not limited to, polling (by the mobile communication device 102 the service 106, a push notification, an SMS message, or an email message). In some implementations, the communication containing the lock command can be received by the lock application, which can then lock the mobile communication device 102 as discussed in greater detail below.

In some implementations, other communications are possible. For example, the mobile communication device 102 can provide an acknowledgement back to the service 106 that the lock command has been received and/or the lock has been implemented. In another example, the mobile communication device 102 can send status or other information back to the service 106 before the lock goes into place. In some implementations, information can be gathered from the mobile communication device 102, such as its location and any activity made on the device since a designated date-time (e.g., the reported time of theft) or going back a threshold period of time. In some implementations, in addition to the locking, the mobile communication device 102 can be commanded to sound an audible alarm that can lead the thief to abandon the stolen device.

In some implementations, other commands or instructions can be provided by the service 106 to perform actions on the mobile communication device 102. In some implementations, the service 106 can instruct the locking application on the mobile communication device 102 to erase user data, e.g., from device memory or from removable memory (e.g., on a secure digital (SD) card), or perform other actions related to data security and privacy protection. In some implementations, one or more access ports (e.g., communication, power, or other access points) or other components of the mobile communication device 102 can be disabled or locked, including camera functionality, sound-related components, and/or other features of the mobile communication device 102.

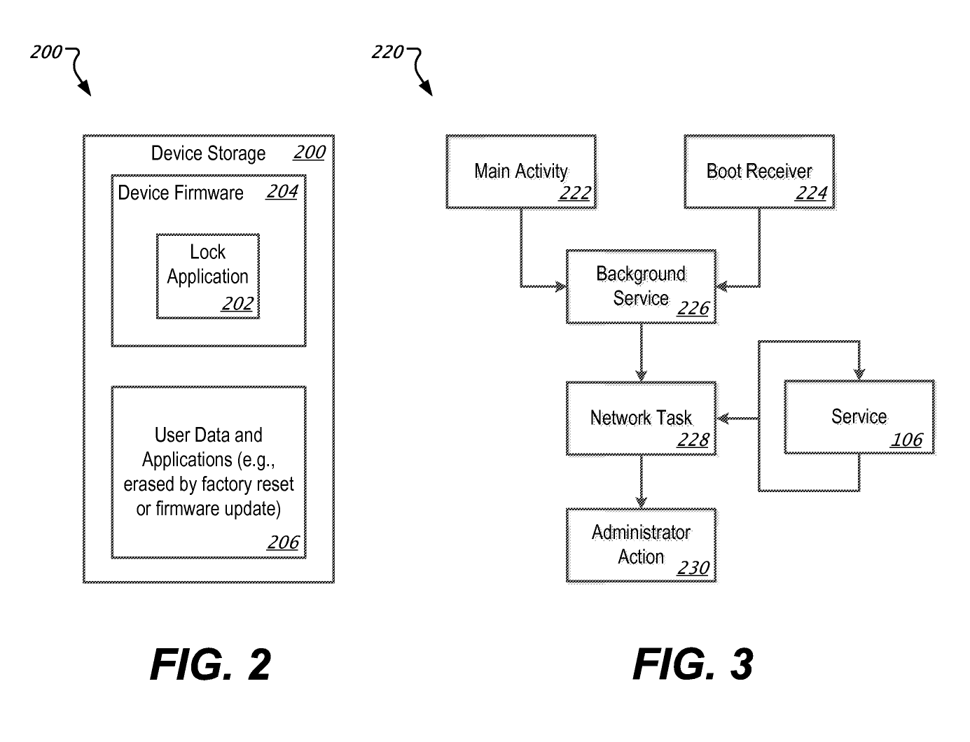

FIG. 2 shows a diagram of an example device storage 200 for a mobile communication device. For example, the device storage 200 can store one or more components used for locking the mobile communication device 102 as described with respect to FIG. 1.

In some implementations, the device storage can include a lock application 202 that is stored in device firmware 204. The device storage 200 can also include user data and applications 206. In some implementations, the user data and applications 206 can be erased by a factory reset or firmware update. As such, storing the lock application in these locations would prove potentially ineffective. Storing the lock application 202 in the device firmware 204 can prevent the lock application 202 (and any results of locking the mobile communication device 102) from being interfered with by non-owner users 108.

FIG. 3 is a diagram of an example environment 220 for locking a mobile communication device, e.g., the mobile communication device 102. Components 222-230 in the environment 220, for example, can reside on a mobile communication device 102.

A main activity engine 222, for example, can be responsible for starting a background service 226 that can run, for example, continuously in background mode on a mobile communication device 102. In some applications, the background service 226 runs periodically. In some implementations, the main activity engine 222 can be part of the firmware that controls the mobile communication device. For example, the main activity engine 222, as well as the components 222-230, can be pre-loaded onto, and provided with, the mobile communication device 102 prior to the time of purchase by the user 104 or at activation time. At activation time, the user 104 who owns the phone can be provided with a communication option (e.g., using an email service) through which, using a different device, the user can report the mobile communication device 102 as lost or stolen and have the mobile communication device 102 locked remotely.

A boot receiver 224, for example, can be (or can be included in) the software that performs a boot-up of the mobile communication device 102. The boot receiver 224 can be responsible, for example, for starting the background service 226 when the mobile communication device is booted up, e.g., at device startup. The boot receiver 224 can also be responsible for facilitating communications between the mobile communication device 102 and the service 106.

The background service 226, for example, can periodically launch the network task 228 for network communication, e.g., including communication between the mobile communication device 102 and the service 106. Network task 228, for example, can continuously and/or periodically check for commands from the service 106 to lock or otherwise configure the mobile communication device 102. Other communications can also occur.

The network task 228, for example, can communicate device status and information to the service 106 and receive automated response commands. One example command sent by the service 106 can be to lock the mobile communication device 102. In some implementations, the network task 228 can transmit the received command to an administrator action component 230 for execution.

The administrator action component 232 can perform required actions at the mobile communication device 102 based on information received from other components within the environment 220, e.g., components 222-228. For example, the administrator action component 232 can perform the required actions using device administrator permissions.

The service 106 can maintain a list of active mobile communication devices. Upon communication with a particular mobile communication device, for example, the service 106 can issues automated responses. These responses can inform the administrator action component 230, for example, to lock, wipe or unlock a particular mobile communication device. In some implementations, the service 106 can send periodic communications to the mobile communication device 102 to remind the user 104 of the protection offered by the service 106 or to receive confirmation (e.g., using a password or a personal identification number (PIN)) that the user 104 is in control of the device.

In some implementations, the service 106 can send unlock messages specifically to the network task 228, or generally to the mobile communication device 102. For example, an unlock command can be used to unlock the mobile communication device 102, such as after the mobile communication device 102 has been recovered by law enforcement. In some implementations, when the mobile communication device 102 is unlocked, a port or other access point on the device (e.g., the USB port) that was previously disabled can be re-enabled, and the password used for locking the device can be removed.

In order to support a plurality of user devices and/or plural network service providers, each mobile communication device must be associated with a unique identifier. The unique identifier ‘can be device dependent, assigned by a manufacturer of the device, or alternatively can be assigned by the service 106 or a network provider (e.g., Verizon, Sprint or others). The unique identifier can be used in communications between the mobile communication device 102 and the service 106.

In some implementations, the unique identifier can be selected from the group of an international mobile subscriber identity (IMSI)-subscriber identity module (SIM) ID, an international mobile station equipment identity (IMEI) device ID, a WiFi media access control (MAC) address, an Android ID (e.g., generated during a factory reset), a unique application ID that is unique to the lock application 202, or combinations of one or more of these. Other identification methods for uniquely identifying the mobile communication device 102 are possible.

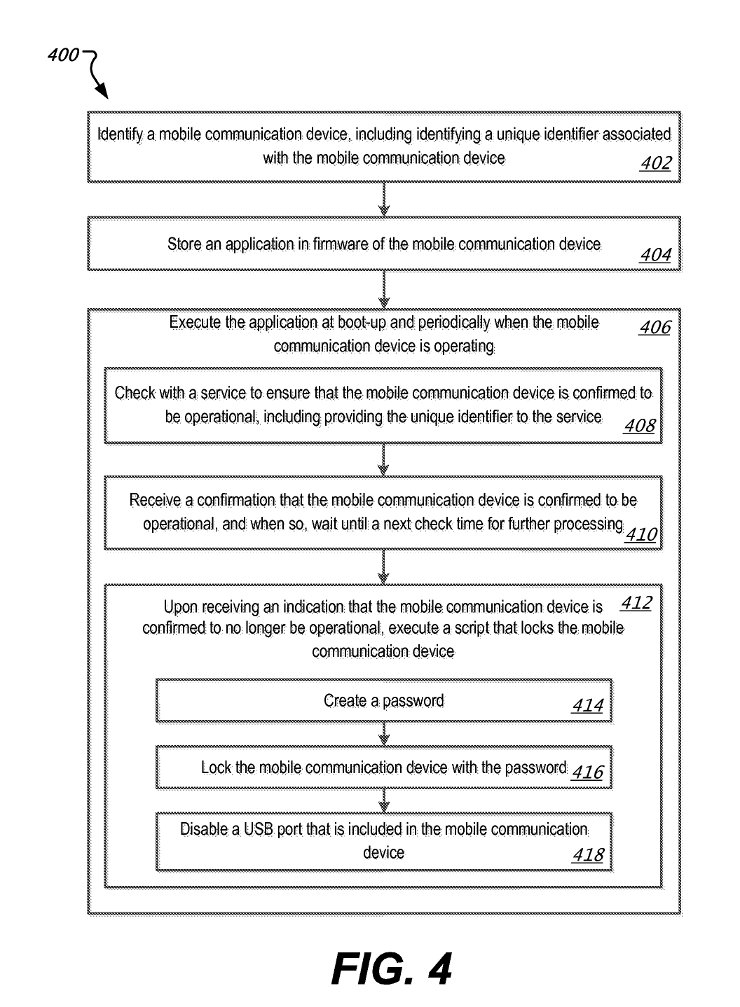

FIG. 4 shows a flowchart of an example of a process 400 for disabling a mobile communication device 102. In some implementations, the lock application 202 can perform stages of the process 400 using instructions that are executed by one or more processors on the mobile communication device 102 or in association with a server executing the service 106. FIGS. 1-3 are used to provide example structures for performing the steps of the process 400.

At 402, a mobile communication device is identified, including identifying a unique identifier associated with the mobile communication device. For example, the mobile communication device 102 can be provided with a unique ID at the time of manufacture or at the time of activation by a phone service provider.

In some implementations, the mobile communication device can be a cellular telephone or a tablet computer, and the service can be a server-based service that is accessed using either a cellular, wifi or other communication network. For example, the mobile communication device 102 can be a cellular phone (e.g., a smartphone) or a tablet computer belonging to the user 104. The service 106, for example, can be a cellular phone provider or some other service that includes one or more servers with which the mobile communication device 102 can communicate using cellular phone communications, wifi communications, or other communications. In some implementations, the service 106 can have links to, and/or interfaces with, law enforcement agencies for use in locking stolen mobile communication devices.

In some implementations, the unique identifier can be associated with the mobile communication device and not a service activated by the device. For example, the unique identifier (e.g., an IMSI SIM ID, IMEI device ID, wifi MAC address, Android ID, or a unique application ID) can be uniquely associated with the mobile communication device 102, and not simply associated generally with the communication service (e.g., cellular telephone service).

At 404, an application is stored in firmware of the mobile communication device. As an example, the lock application 202 can be stored in the device firmware 204 on the mobile communication device 102.

In some implementations, storing the application can include pre-loading the application in the firmware in a system partition. For example, when the mobile communication device 102 is manufactured, or when activated for use by the user 104, the lock application 202 can be stored in the device firmware 204.

At 406, the application is executed at boot-up and periodically or continuously when the mobile communication device is operating. For example, when the mobile communication device 102 is powered up, re-booted, and/or at other times, the lock application 202 can be started.

At 408, the application checks with a service to ensure that the mobile communication device is confirmed to be operational (e.g., has not been stolen, lost or otherwise compromised), including providing the unique identifier to the service. For example, the mobile communication device 102, or specifically the network task 228, can communicate with the service 106. The communication can include, for example, a device ID or some other unique identifier for the mobile communication device 102.

At 410, the application receives a confirmation that the mobile communication device is confirmed to be operational, and when so, the application waits until a next check time for further processing. For example, if the service 106 has no knowledge that the mobile communication device 102 has been compromised, then there is no reason to send a lock command, and the mobile communication device 102 can continue operating until at least a later time that another check is made.

In some implementations, the process 400 can further include receiving, at the service, an indication (e.g., from an owner of the mobile communication device) that the device has been compromised, and providing, by the service, the indication. For example, when the user 104 discovers that the user's mobile communication device 102 has been stolen, the user 104 can contact the service 106, e.g., by phone, by email, using the Internet, or in other ways. The service 106 can then send a lock command to the mobile communication device 102.

At 412, upon receiving an indication that the mobile communication device is confirmed to no longer be operational, the application executes a script that locks the mobile communication device. For example, when the lock application 202 receives a lock command from the service 106, the lock application 202 can lock the mobile communication device 102. In some implementations, locking the mobile communication device 102 can include the numerous actions.

At 414, a password is created. For example, the lock application 202 can create a random or pseudo random alphanumeric or other type of password, including any combination of alphabetic, numeric or special characters. Other types of passwords are possible.

In some implementations, creating the password can include generating a random alphanumeric string and using the random alphanumeric string as the password for the device. For example, the lock application 202 can include a random password generator that is invoked to create a password consisting of random alphanumeric and, optionally, special characters.

In some implementations, the mobile communication device can be an Android telephone, and locking and creating a password can include using one or more Android application programming interfaces (APIs) to facilitate the locking and password creation. For example, the mobile communication device 102 can be a smart phone or other mobile device using the Android operating system that includes one or more Android APIs that are resident on the mobile communication device 102.

At 416, the mobile communication device is locked with the password. As an example, the lock application 202 can lock the mobile communication device 102 using the created password. Since the password is unknown to the user and also to others (i.e., it is not shared with anyone), the mobile communication device can be effectively locked.

At 418, an access point (e.g. a USB port) that is included in the mobile communication device is disabled. For example, as part of the locking action, the lock application 202 can disable (e.g., also within the device's firmware) the USB port on the mobile communication device 102. Disabling other types of access points or ports is possible.

In some implementations, the process 400 can further include: determining, by the application, that a factory reset of the mobile communication device has occurred or that the firmware has been re-written; determining a previous locked state of the mobile communication device; and locking the mobile communication device after the factory reset or the firmware re-write based on the previous locked condition. For example, the lock application 202 can detect when the mobile communication device 102 has undergone a factory reset, including re-writing the device firmware 204. In this example, the lock application 202 can determine (e.g., using information obtained from the service 106) that the mobile communication device 102 was previously locked, and if so, re-lock the mobile communication device 102.

In some implementations, the process 400 can further include providing a status update to the service that the mobile communication device has been locked. The status update can confirm both receipt of the lock command as well as the operations associated with the lock have been completed.

In some implementations, the process 400 can further include determining, by the application, that the mobile communication device has been used unpredictably and locking the mobile communication device. For example, the lock application 202 can lock the mobile communication device 102 if it determined that a user has attempted to defeat locking provisions on the mobile communication device 102. Examples of unpredictable use include use of the device in countries other than where the user is resident, or use that is outside a predicted pattern of usage associated with the user.

In some implementations, the process 400 can further include providing a status update to the service that the mobile communication device has been locked based on the detected unpredictability, receiving an unlock command from the service when the mobile communication device is confirmed to be operational, and unlocking the mobile communication device. For example, the lock application 202 can notify the service 106 that a specific unpredictability event has occurred. Subsequently, the service 106 can communicate to the lock application 202 that the mobile communication device 102 is operational, and the lock application 202 can unlock the device.

In some implementations, the process 400 can further include detecting that a SIM card in the mobile communication device has been removed, and locking the mobile communication device. As an example, the lock application 202 or some other component of the mobile communication device 102 can determine (e.g., as it occurs) that someone has removed the SIM card, and when this occurs, the lock application 202 can lock the mobile communication device 102.

In some implementations, the process 400 can further include providing a status update to the service that the mobile communication device has been locked based on the removal of the SIM card, receiving an unlock command from the service when the mobile communication device is confirmed to be operational, and unlocking the mobile communication device. For example, upon locking the mobile communication device 102, the lock application 202 can notify the service 106 that the locking has occurred. Subsequently, the user 104 can contact the service 106, e.g., requesting an unlock of the mobile communication device 102 and providing credentials that indicate that the user 104 is the true owner of the device. The service 106 can then send an unlock command to the mobile communication device 102, causing the mobile communication device 102 to be unlocked.

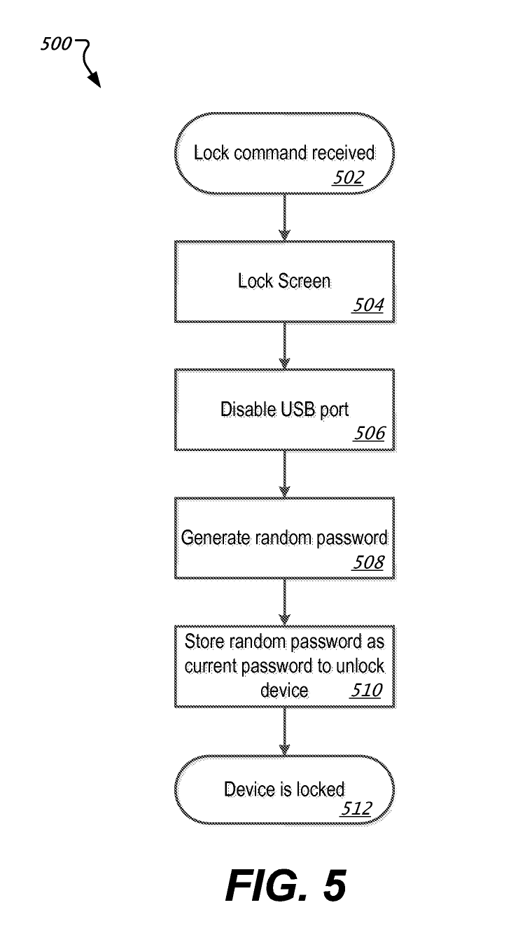

FIG. 5 shows a flowchart of an example of a process 500 for locking a mobile communication device. For example, the process 500 can include steps taken by the lock application 202 in locking the mobile communication device 102.

At 502, a lock command is received. For example, the lock application 202 can receive a lock command from the service 106 for locking the mobile communication device 102.

At 504, the screen is locked. The lock application 202, for example, can lock the screen on the mobile communication device 102, including, for example, a display associated with the mobile communication device 102.

At 506, one or more external ports (the USB port) is disabled. As an example, the lock application 202 can disable the USB port on the mobile communication device 102. In some implementations, other components of the mobile communication device 102 can be locked or disabled at this time.

At 508, a random or pseudo-random password is generated. For example, the lock application 202 can generate a random alpha-numeric password, e.g., that may or may not include special characters.

At 510, the random password is stored as the current password to unlock the device. As an example, the lock application 202 can store the random password, e.g., replacing the existing user-specified password for locking the mobile communication device 102.

At 512, the device is locked. For example, the lock application 202 can use the stored password to lock the mobile communication device 102.

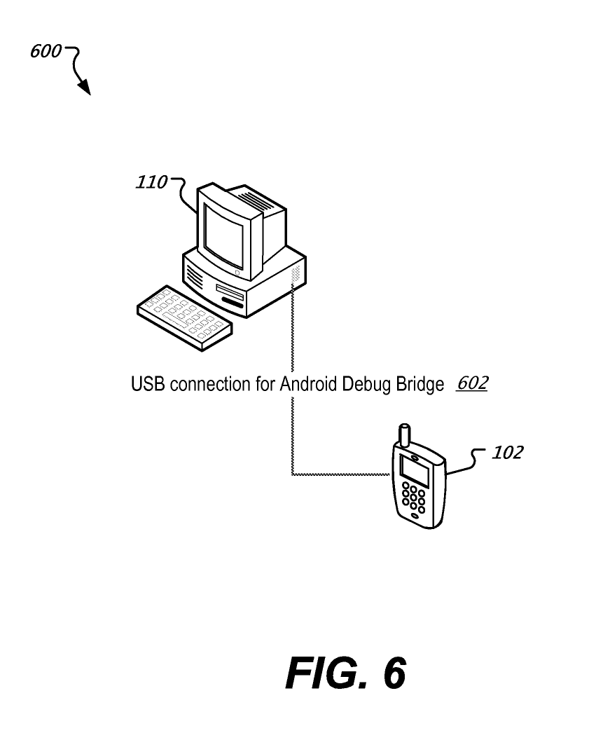

FIG. 6 shows a diagram of an example configuration 600 of the mobile communication device 102 connected to the external computer 110. For example, this connection can be made using a USB port on the mobile communication device 102. If the mobile communication device 102 is locked, however, then the USB port can also be locked or otherwise disabled, e.g., preventing device-to-device communication using USB connection shown FIG. 6.

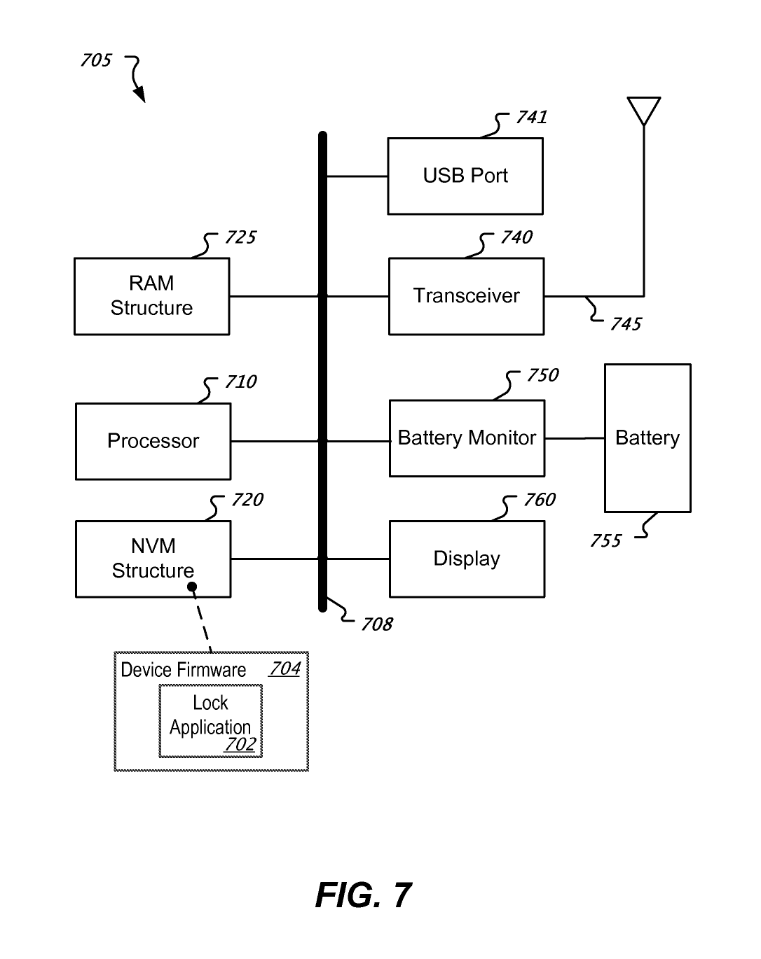

FIG. 7 shows a simplified architecture of an example of a mobile communication device (e.g., the wireless device 705, which can also be the mobile communication device 102). The wireless device 705 includes a processor 710, non-volatile memory (NVM) structure 720, random-access memory (RAM) structure 725, display 760, transceiver 740, antenna 745, battery 755, and a batter monitor 750. The wireless device 705 can include other components not shown such as a keyboard, camera, and motion sensors. A bus structure 708 can interconnect components within the wireless device 705.

The wireless device 705 can send and receive data packets over one or more wired or wireless interfaces. For example, the wireless device's processor 710 can send and receive data packets via one or more transceivers 740 and antennas 745. Various examples of wireless interface technology include interfaces based on Long Term Evolution (LTE), Global System for Mobile Communications (GSM), IEEE 802. 11a/b/g/n/ac, and Code Division Multiple Access (CDMA) technologies such as CDMA2000 and WCDMA. Other types of wireless interface technologies are possible. The wireless device 705 can download application software over one or more of these wired or wireless interfaces and store the application software on a memory structure such as the NVM structure 720 or the RAM structure 725.

The NVM structure 720 stores software such as a wireless device OS and application software such as a lock application 702 (e.g., the lock application 202). The processor 710 can load software from the NVM structure 720 into the RAM structure 725, and can execute the software from the RAM structure 725. In some implementations, the processor 710 directly executes software from the NVM structure 720. In some implementations, the processor 710 includes multiple processor cores.

The lock application 702 can be stored in firmware 704 (e.g., the device firmware 204). Other configurations of memory and firmware are possible. When the lock application 702 executes (e.g., using the processor 710), the lock application 702 can lock the display 760 using a random password as described above. The lock application 702 can also lock a USB port 741, e.g., to prevent a connection to an external computer that may be used to defeat locking mechanisms on the wireless device 705.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for detecting impersonation on a social network may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method comprising:
identifying a mobile communication device, including identifying a unique identifier associated with the mobile communication device;
storing an application in firmware of the mobile communication device; and
executing the application at boot-up and periodically when the mobile communication device is operating, including:
checking with a service to ensure that the mobile communication device is confirmed to be operational, including providing the unique identifier to the service;
receiving a confirmation that the mobile communication device is confirmed to be operational, and when so, waiting until a next check time for further processing; and
upon receiving an indication that the mobile communication device is confirmed to no longer be operational, executing a script that locks the mobile communication device, including:
creating a password;
locking the mobile communication device with the password; and
disabling a USB port that is included in the mobile communication device.

2. The method of claim 1, wherein the mobile communication device is a cellular telephone or a tablet computer, and wherein the service is a server based service that is accessed using either a cellular, wifi or other communication network.

3. The method of claim 1, wherein the unique identifier is associated with the mobile communication device and not a service activated by the device.

4. The method of claim 1, wherein the unique identifier is IMSI SIM ID, IMEI Device ID, wifi MAC address, Android ID, or a unique application ID.

5. The method of claim 1, wherein storing the application includes pre-loading the application in the firmware in a system partition.

6. The method of claim 1, further comprising:
receiving, at the service, an indication from an owner of the mobile communication device that the device has been compromised; and
providing, by the service, the indication.

7. The method of claim 1, wherein creating the password includes generating a random alphanumeric string and using the random alphanumeric string as the password.

8. The method of claim 1, wherein the mobile communication device is an Android device, and wherein locking and creating a password includes using an Android API to facilitate the locking and password creation.

9. The method of claim 1, further comprising:
determining, by the application, that a factory reset of the mobile communication device has occurred or that the firmware has been re-written;
determining a previous locked state of the mobile communication device; and
locking the mobile communication device after the factory reset or the firmware re-write based on the previous locked condition.

10. The method of claim 1, further comprising:
determining by the application that the mobile communication device has been used unpredictably; and
locking the mobile communication device.

11. The method of claim 10, further comprising:
providing a status update to the service that the mobile communication device has been locked based on the detected unpredictability;
receiving an unlock command from the service when the mobile communication device is confirmed to be operational; and
unlocking the mobile communication device.

12. The method of claim 1, further comprising:
detecting that a SIM card in the mobile communication device has been removed; and
locking the mobile communication device.

13. The method of claim 1, further comprising:
providing a status update to the service that the mobile communication device has been locked based on the removal of the SIM card;
receiving an unlock command from the service when the mobile communication device is confirmed to be operational; and
unlocking the mobile communication device.

14. A computer program product embodied in a non-transitive computer-readable medium including instructions, that when executed, cause one or more processors to:
identifying a mobile communication device, including identifying a unique identifier associated with the mobile communication device;
storing an application in firmware of the mobile communication device; and
executing the application at boot-up and periodically when the mobile communication device is operating, including:
checking with a service to ensure that the mobile communication device is confirmed to be operational, including providing the unique identifier to the service;
receiving a confirmation that the mobile communication device is confirmed to be operational, and when so, waiting until a next check time for further processing; and
upon receiving an indication that the mobile communication device is confirmed to no longer be operational, executing a script that locks the mobile communication device, including:
creating a password;
locking the mobile communication device with the password; and
disabling a USB port that is included in the mobile communication device.

15. A system comprising:
a mobile communication device including a memory, the memory including firmware that configures and operates the mobile communication device; and
a server component that includes a service for communicating with the mobile communication device, wherein the service is operable to communicate with the mobile communication device periodically to validate the current operational status of the mobile communication device; wherein
the mobile communication device includes an application that is stored in the firmware that is configured to periodically communicate with the service and, upon receipt of a lock command, to lock the mobile communication device including creating a new password for use in locking the device, locking the device using the new password, and disabling an external communication port of the mobile communication device.
